(19) United States
(12) Patent Application Publication
(10) Pub. No.: US 2011/0059416 A1
(43) Pub. Date: Mar. 10, 2011

(54) ASSISTANT APPARATUS FOR ORAL TREATMENT AND UNIT CHAIR WITH THE SAME

(75) Inventor: Ul-Ho Lee, Gyeonggi-do (KR)

(73) Assignee: MEDIWIDE CO., LTD., Gangwon-do (KR)

(21) Appl. No.: 12/674,128

(22) PCT Filed: Aug. 14, 2008
(86) PCT No.: PCT/KR08/04719

§ 371 Date: Feb. 18, 2010

(30) Foreign Application Priority Data
Aug. 31, 2007 (KR) 10 2007 0088004
Jun. 27, 2008 (KR) 10 2008 0061702

(51) Int. Cl. A61C 19/00

(52) U.S. Cl. 433/33; 433/25

(57) ABSTRACT

Provided is an assistant apparatus for oral treatment including dental treatment and a unit chair equipped with the same. The assistant apparatus includes an oral cavity insertion member positioned in the oral cavity in front of the uvula of a patient, or preferably, on the soft palate, such that washing liquid or saliva is prevented from entering a patient's throat during oral treatment. Therefore, it is possible to prevent patient discomfort and interruption of treatment. Further, medical instruments/components are prevented from entering the throat and injuring the pharynx.

### TECHNICAL FIELD

The present invention relates to an assistant apparatus for oral treatment including dental treatment and a unit chair with the same, and more specifically, to an assistant apparatus which prevents the blood of a patient or washing liquid from entering a patient's throat during oral treatment and also prevents a medical instrument or component from entering the throat of a patient such that the pharynx of the patient is not injured by the medical instrument or component.

### BACKGROUND ART

In general, during oral treatment including a dental treatment, a patient sits on a unit chair, the chair is reclined, and then the patient is treated using various instruments provided on the unit chair.

Since the chair is reclined and the patient is substantially horizontal, washing liquid or the patient's blood or saliva stays in the oral cavity during the oral treatment and is then discharged to the outside through a fluid suction unit provided on the unit chair.

Although the washing liquid, blood or saliva is discharged to the outside through the fluid suction unit, it is not discharged immediately. Therefore, the patient has to roll his/her tongue back to block the washing liquid, blood or saliva from entering the gullet or airway through the throat.

Further, although the patient tries to block his/her throat with his/her tongue, some of the washing liquid, blood, or saliva inevitably enters the throat and is swallowed. This causes an unpleasant feeling and movement of the oral cavity which interrupts the treatment.

Further, during the oral treatment, in addition to healthcare practitioners such as a dentist and nurse, a separate assistant is needed to position a suction tube of the fluid suction unit in the oral cavity such that fluid can be suctioned out. When a healthcare practitioner suctions out the fluid without such an assistant, either treatment must be interrupted or the healthcare practitioner must operate a treatment tool and the suction tube simultaneously.

Further, when the healthcare practitioner accidently drops a medical instrument or component used during the oral treatment, it may penetrate the skin inside the oral cavity or enter the throat and injure the patient's pharynx.

Recently, a treatment method using a rubber dam for dental surgery is being used to prevent contamination of an affected part during dental treatment.

The rubber dam formed of a thin latex film is put between the patient's teeth and clamped in place.

However, the clamp should be checked and fixed in accordance with the structure of the oral cavity. Further, although a region blocked by the rubber dam can block external matter (washing liquid and so on) from entering the throat, it cannot block saliva formed in the oral cavity during treatment.

Therefore, during treatment using a rubber dam, the patient still has to block saliva from entering the throat with his/her tongue. Further, an additional process of fixing the rubber dam is required.

### DISCLOSURE

Technical Problem

The present invention is directed to an assistant apparatus for oral treatment that prevents washing liquid or saliva from entering a patient's throat during oral treatment, thereby preventing patient inconvenience and treatment interruption.

The present invention is also directed to an assistant apparatus for oral treatment that prevents a medical instrument or component from approaching a patient's skin or pharynx when the medical instrument or component is accidentally dropped by a healthcare practitioner, thereby preventing patient injury.

The present invention is also directed to an assistant apparatus for oral treatment that can be used without a separate assistant to operate a fluid suction unit during oral treatment.

Technical Solution

According to an aspect of the present invention, an assistant apparatus for oral treatment includes: an oral cavity insertion member that includes an adjustable volume portion of which volume is expandable by fluid; and a fluid supply configured to supply the fluid to the adjustable volume portion.

According to another aspect of the present invention, an assistant apparatus for oral treatment includes an oral cavity insertion member that is inserted into an oral cavity in front of a uvula of a patient to prevent washing liquid used during the oral treatment or saliva from entering a gullet or an airway of the patient.

According to still another aspect of the present invention, an assistant apparatus for oral treatment includes an oral cavity insertion member including: a body portion that includes a connection path through which fluid is able to flow; an oral cavity adhesion portion that is provided on an outer circumference of the body portion and adhered to skin inside an oral cavity of a patient; and at least one fluid suction holes that is formed on one surface of the oral cavity adhesion portion to be connected to the connection path.

According to yet another aspect of the present invention, an assistant apparatus for oral treatment includes an oral cavity insertion member including: a body portion having a predetermined thickness; and an oral cavity adhesion portion that is provided on the outer circumference of the body portion and is thinner than the predetermined thickness of the body portion.

According to yet another aspect of the present invention, a unit chair for oral treatment includes an oral cavity insertion member including: a body portion having a connection path formed therein, through the connection path fluid is able to flow; an oral cavity adhesion portion that is provided on an outer circumference of the body portion and adhered to skin inside an oral cavity of a patient; and at least one fluid suction holes that is formed on one surface of the oral cavity adhesion portion to be connected to the connection path; and a fluid suction unit that is connected to the connection path and provides a negative pressure to the fluid suction holes.

Advantageous Effects

According to the present invention, during oral treatment, washing liquid or saliva can be prevented from entering a patient's throat. Therefore, it is possible to prevent patient inconvenience and treatment interruption.

Further, even when a healthcare practitioner accidently drops a medical instrument or component used during oral treatment, the assistant apparatus can prevent injury to the skin inside the oral cavity or the pharynx.

Further, a healthcare practitioner such as a dentist or nurse performing oral treatment without a separate assistant to operate a fluid suction unit can suction out washing liquid or saliva from the oral cavity without separate or additional tool manipulation.

Other objects, features and advantages of the present invention will be made more apparent by illustrating and describing in detail exemplary embodiments of the invention below.

### DESCRIPTION OF DRAWINGS

FIG. 1 is a side view showing a state in which an assistant apparatus for oral treatment according to an example embodiment of the present invention is coupled to the oral cavity of a patient.

FIG. 2 is a front view of the oral cavity, showing a state in which an assistant apparatus for oral treatment according to an example embodiment of the present invention is coupled to the oral cavity.

FIG. 3 is a perspective view of the assistant apparatus for oral treatment according to an example embodiment of the present invention.

FIG. 4 is a cross-sectional view of an oral cavity insertion member of FIG. 3, taken along a line I-I′.

FIG. 5 is a cross-sectional view of a modification of the oral cavity insertion member taken along a line I-I′ of FIG. 3 according to another example embodiment of the present invention.

FIG. 6 is a perspective view of an assistant apparatus for oral treatment according to another example embodiment of the present invention.

FIG. 7 is a cross-sectional view of an oral cavity insertion member of FIG. 6, taken along a line

FIG. 8 is a perspective view of an assistant apparatus for oral treatment according to a further example embodiment of the present invention.

FIG. 9 is a cross-sectional view of an oral cavity insertion member of FIG. 8, taken along a line

FIG. 10 is a perspective view of an assistant apparatus for oral treatment according to still another example embodiment of the present invention.

FIG. 11 is a cross-sectional view of an oral cavity insertion member of FIG. 10, taken along a line IV-IV′.

FIG. 12 is a diagram showing the structure of a fluid supply according to the present invention.

FIG. 13 is a front perspective view of an assistant apparatus for oral treatment according to still another example embodiment of the present invention.

FIG. 14 is a rear perspective view of the assistant apparatus shown in FIG. 13.

FIG. 15 is an exploded cross-sectional view of an oral cavity insertion member of FIG. 13.

FIG. 16 is a rear view of the oral cavity insertion member of FIG. 13.

FIG. 17 is a front view of the oral cavity insertion member of FIG. 13.

FIGS. 18 and 19 are cross-sectional views of the oral cavity insertion member of FIG. 17, taken along lines V-V′ and VI-VI′, respectively.

FIG. 20 is a perspective view of the oral cavity of a patient before the assistant apparatus for oral treatment according to the present invention is inserted.

FIG. 21 is a perspective view of the oral cavity when the assistant apparatus for oral treatment is coupled to the oral cavity.

FIG. 22 is a diagram showing a state in which an assistant apparatus for oral treatment according to an example embodiment of the present invention is coupled to a unit chair.

FIG. 23 is an expanded view of a region VII of FIG. 22, illustrating a connector according to the present invention.

FIG. 24 is a perspective view of an assistant apparatus for oral treatment according to still another example embodiment of the present invention.

Description of reference numerals of Main Elements in Drawings

10000, 11000, 12000: Oral cavity insertion member

10100, 10200: Coupling terminal, 11100: Inflatable membrane

11200: Adjustable volume portion, 11110: Convex portion

11200: Fixed volume portion, 11310: First fluid passage portion

11320: Fluid injection hole, 11400: Oral cavity adhesion portion

11410: Second fluid passage portion, 11420: Fluid suction hole

12100: Body portion, 12200: Oral cavity adhesion portion

12220: Fluid suction hole, 12300: Respiration hole

12400: Bonding portion, 21000: Fluid supply

22000: Fluid suction unit, 30000: Connector

41000, 42000: Fluid transfer tube, 50000: Unit chair

### MODE FOR INVENTION

According to example embodiments of the present invention, the oral cavity and the throat (including the pharynx and the larynx) of a patient are blocked by positioning an oral cavity insertion member in front of the uvula, or preferably, on the soft palate during oral treatment. Therefore, washing liquid used during the oral treatment, the patient's saliva and blood, as well as treatment instruments can be prevented from entering the throat.

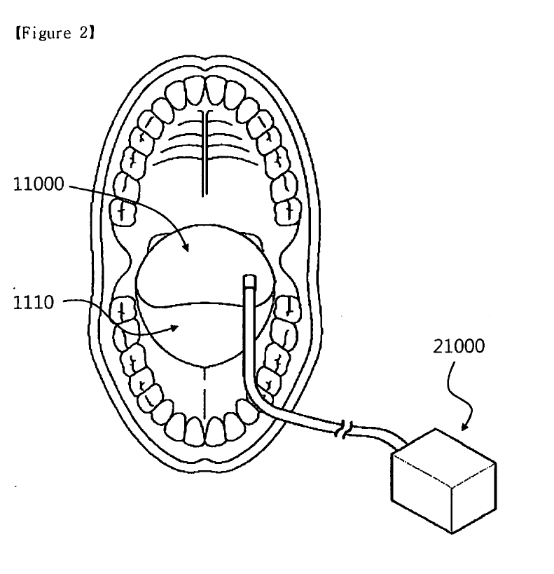

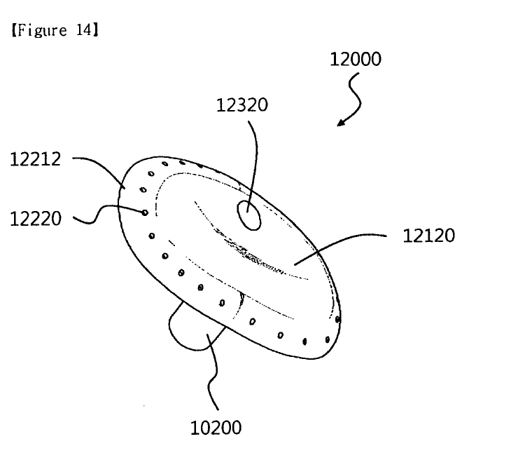

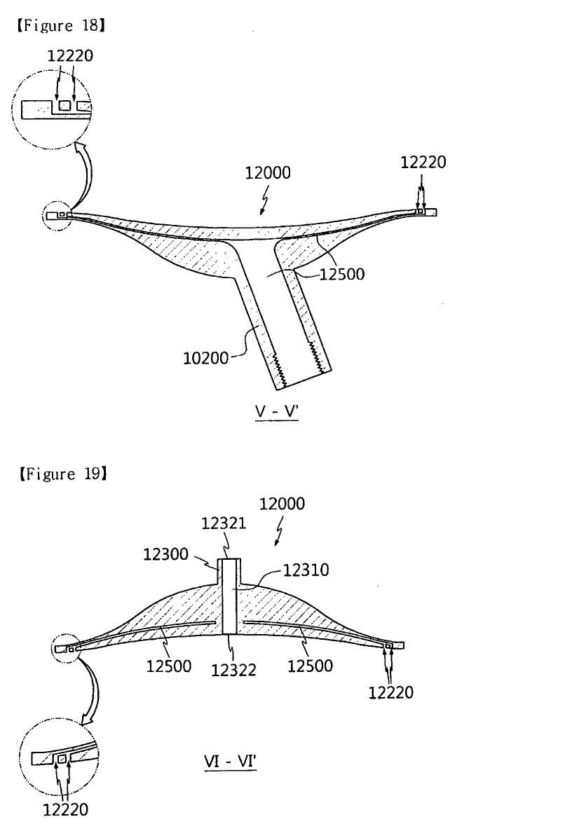

Referring to FIGS. 2 to 12, an example in which the volume of an oral cavity insertion member according to an example embodiment of the present invention is changed by a positive pressure will be described. Further, referring to FIGS. 13 to 23, an example in which an oral cavity insertion member according to another example embodiment of the present invention adheres to the oral cavity by a negative pressure will be described.

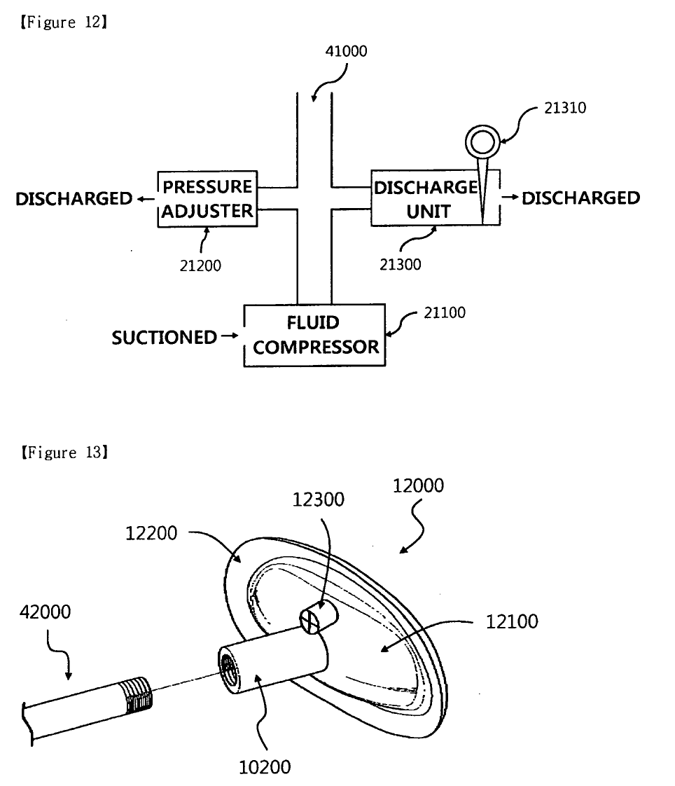

In an example embodiment of FIGS. 11 and 12, a positive pressure and a negative pressure may be used together.

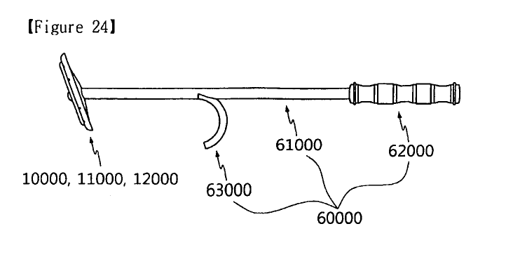

In an example. embodiment of FIG. 24, an oral cavity insertion member may be used without a positive pressure and a negative press.

Hereinafter, example embodiments of the present invention will be described with reference to the accompanying drawings.

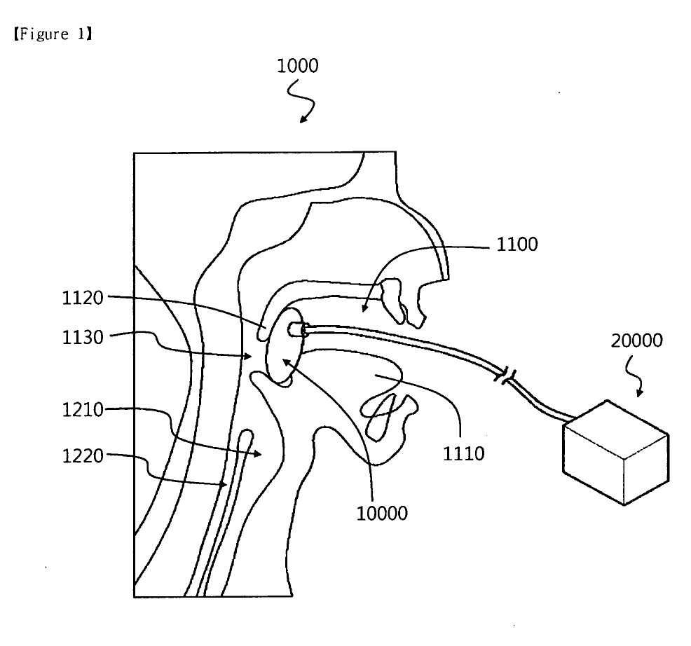

FIG. 1 is a diagram showing a state in which an oral cavity insertion member of an assistant apparatus for oral treatment according to an example embodiment of the present invention is coupled to the oral cavity of a patient.

A patient 1000 having oral treatment lies on a chair (unit chair) and opens his/her mouth to expose his/her oral cavity 1100. A healthcare practitioner such as a doctor or nurse inserts an oral cavity insertion member 10000 into the oral cavity 1100. The healthcare practitioner positions the oral cavity insertion member 10000 in front of the uvula 1120, or specifically, on the soft palate and a rear portion of the tongue such that washing liquid, saliva, and medical instruments/components used during the oral treatment are prevented from entering the throat 1130. The healthcare practitioner supplies fluid to or suctions fluid from the oral cavity insertion member 10000 through a pump 20000 such as a fluid supply or fluid suction unit such that the volume of the oral cavity insertion member 10000 expands due to a positive pressure or adheres to the oral cavity through adhesion holes included in the oral cavity insertion member 10000 due to a negative pressure.

Each patient 1000 has an oral cavity with a different structure and size. Therefore, while the oral cavity insertion member 10000 expands or adheres to the oral cavity through the adhesion holes, a path from the front of the oral cavity 1100 to the throat 1130 is blocked.

Alternatively, the pump 20000 may be not connected to the oral cavity insertion member 10000. In this case, as shown in FIG. 24, the oral cavity insertion member 10000 may be used in a state in which it is positioned in front of the uvula 1120, or specifically, on the soft palate and the rear portion of the tongue.

At this time, when the patient is treated, he/she lies in the chair. Therefore, the oral cavity insertion member 10000 is held in a stable position. Thereafter, as shown in FIG. 24, the oral cavity insertion member 10000 may be continuously supported by a handle member. Further, an adhesive material may be applied to a surface of the oral cavity insertion member, which comes in contact with the skin inside the oral cavity.

FIG. 2 is a front view of the oral cavity of a patient, showing a state in which an oral cavity insertion member of an assistant apparatus for oral treatment according to an example embodiment of the present invention is coupled to the oral cavity. Referring to FIG. 2, an oral cavity insertion member 11000 using a positive pressure will be described.

As the oral cavity insertion member 11000 is positioned deep inside the oral cavity 1100 in front of the uvula 1120, or preferably, on the soft palate, in a state in which the patient's mouth is open, the oral cavity insertion member 11000 does not obstruct treatment instruments when a healthcare practitioner treats the patient 1000.

Further, since it is positioned on the tongue 1110, the oral cavity insertion member 11000 may be formed in a half-moon or new-moon shape.

For a fluid supply 21000, a separate compressor may be used. Alternatively, an air pump included in the unit chair may be used. When a separate compressor is used, a manual or electric pump may be used.

For the fluid, gas such as air, oxygen, or nitrogen, or liquid such as water, may be used. In this example embodiment of the present invention, air is used as the fluid and an electric air pump is used as the compressor.

Since the volume of the oral cavity insertion member 11000 can be changed by a positive pressure, the oral cavity insertion member 11000 can be effectively used for various oral cavity structures.

FIG. 3 is a perspective view of the assistant apparatus for oral treatment according to an example embodiment of the present invention. The assistant apparatus for oral treatment includes the positive pressure-type oral cavity insertion member 11000 and the fluid supply 21000 which supplies fluid to the oral cavity insertion member 11000.

The oral cavity insertion member 11000 includes a coupling terminal 10100 for injecting fluid supplied from the fluid supply 21000 and an adjustable volume portion 11200 whose volume changes when the fluid is supplied.

The fluid supply 21000 supplies fluid to the oral cavity insertion member 11000 through a fluid transfer tube 41000 connected to the fluid-injection coupling terminal 10100 of the oral cavity insertion member 11000, thereby expanding the volume of the adjustable volume portion 11200.

The assistant apparatus for oral treatment may further include a fluid suction unit 22000 for discharging washing liquid or saliva from the oral cavity 1100 to the outside during oral treatment.

For the fluid suction unit 22000, a separate pump may be used or an air pump included in the unit chair may be used. When a separate pump is used, it may be a manual or electric pump.

In this example embodiment of the present invention, an air pump included in the unit chair, that is, a suction instrument which is generally used in dental treatment, is used as the fluid suction unit 22000.

The fluid suction unit 22000 is connected to a coupling terminal 10200 included in the oral cavity insertion member 11000 through a fluid transfer tube 42100.

Further, the coupling terminal 10200 of the oral cavity insertion member 11000 may also be coupled to a fluid transfer tube 42200 for positioning a suction port in the oral cavity 1100.

As such, the healthcare practitioner can suction washing liquid or salvia out of the oral cavity through the fluid transfer tubes 42100 and 42200 connected to the fluid suction unit 22000 during dental treatment without a separate assistant.

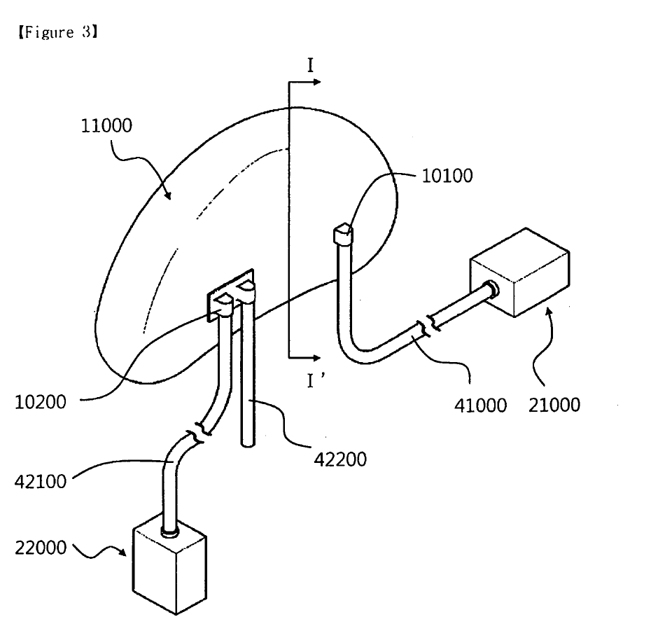

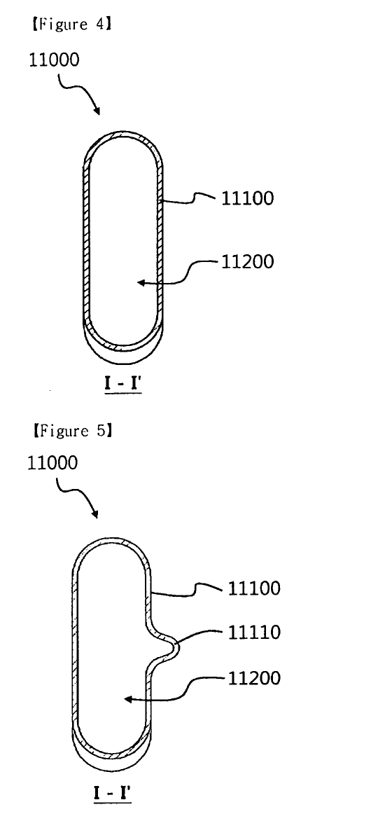

In other example embodiments of the present invention which will be described with reference to FIGS. 4 to 24, the fluid suction unit 22000 and the fluid transfer tubes 42100 and 42200, which are illustrated in FIG. 3 and serve to suction washing liquid or salvia out of the oral cavity, are not shown. However, the fluid suction unit 22000 and the fluid transfer tubes 42100 and 42200 can be applied to the example embodiments.

FIGS.. 4 and 5 are cross-sectional views of the oral cavity insertion member of FIG. 3, taken along a line I-P.

The adjustable volume portion 11200 of the oral cavity insertion member 11000 is formed of an inflatable membrane 11100 composed of an elastic material, and fluid is supplied into the adjustable volume portion 11200.

The inflatable membrane 11100 may be composed of polymer. For example, an elastic material such as polyester, polyimide, or silicon, which is the material of a balloon catheter used in angioplasty or urethral dilation, may be used.

FIG. 5 is cross-sectional view of a modification of the oral cavity insertion member 11000 shown in FIG. 4. While the oral cavity insertion member 11000 shown in FIG. 4 is positioned in front of the throat 1130 of the patient 1000 such that fluid is prevented from entering the throat 1130, the oral cavity insertion member 11000 shown in FIG. 5 includes a convex portion 11110 which is inserted into the throat 1130 of the patient 1000.

The convex portion 11110 serves to prevent washing liquid or saliva that is not blocked by the oral cavity insertion member 11000 shown in FIG. 4 from entering the throat 1130.

Therefore, the size of the convex portion 11110 when the adjustable volume portion 11200 is expanded may be set to be slightly larger than the throat 1130 of the patient. When the convex portion 11110 is inserted into the throat 1130, the shape of the convex portion may change like a balloon.

Further, when the convex portion 11110 is inserted into the throat 1130, it may cause the patient to emesis. Therefore, mucous fluid, which is generally applied on an endoscope in an endoscopy, may be applied on the surface of the convex portion 11110.

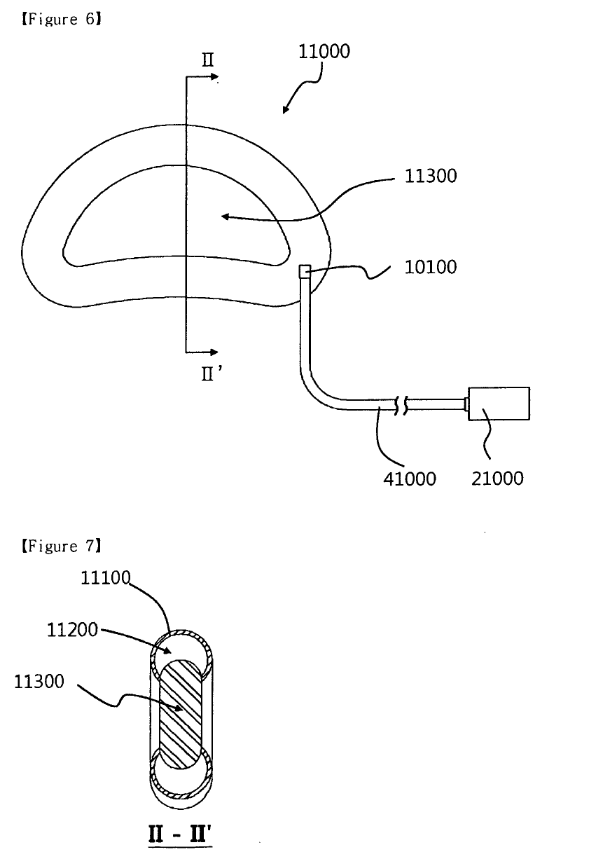

FIG. 6 is a perspective view of an assistant apparatus for oral treatment according to another example embodiment of the present invention. FIG. 7 is a cross-sectional view of an oral cavity insertion member of FIG. 6, taken along a line II-II′.

The oral cavity insertion member 11000 is divided into an adjustable volume portion 11200 and a fixed volume portion 11300.

The adjustable volume portion 11200 is fixed to the outer circumference (circular arc) of the fixed volume portion 11300, like the tire on an automobile wheel.

A fluid-injection coupling terminal 10100 is provided in a predetermined region of the adjustable volume portion 11200. The adjustable volume portion 11200 is expanded by fluid (preferably, air) supplied by the fluid supply 21000 to adhere an inflatable membrane 11100 to the skin inside the oral cavity.

The fixed volume portion 11300 is formed of a material having a lower elasticity than the adjustable volume portion 11200. Any material may be used as long as it is not harmful to the body. In this example embodiment, silicon is used.

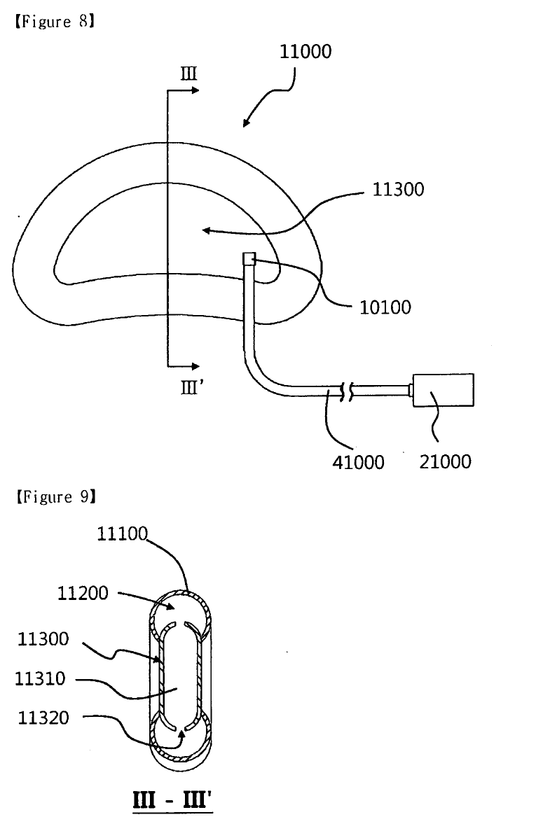

FIG. 8 is a perspective view of an assistant apparatus for oral treatment according to a further example embodiment of the present invention. FIG. 9 is a cross-sectional view of an oral cavity insertion member of FIG. 8, taken along a line III-III′.

The oral cavity insertion member 11000 is roughly divided into an adjustable volume portion 11200 and a fixed volume portion 11300.

The adjustable volume portion 11200 is fixed to the outer circumference (circular arc) of the fixed volume portion 11300, like a tire on an automobile wheel.

A fluid-injection coupling terminal 10100 is provided in a predetermined region of the fixed volume portion 11300. The adjustable volume portion 11200 is expanded by fluid (preferably, air) supplied by the fluid supply 21000. More specifically, the adjustable volume portion 11200 is expanded through a first fluid passage portion 11310 provided inside the fixed volume portion 11300 and one or more fluid injection holes 11320 formed in a region where the fixed volume portion 11300 and the adjustable volume portion 11200 are coupled to each other, thereby adhering an inflatable membrane 11100 to the oral cavity.

The fixed volume portion 11300 is formed of a material having a lower elasticity than the adjustable volume portion 11200. Any material may be used as long as it is not harmful to the body. In this example embodiment, silicon is used.

As its name indicates, the volume of the fixed volume portion 11300 is fixed. Actually, the volume of the fixed volume portion 11300 may change somewhat due to an increase in internal pressure of the first fluid passage portion 11310, even though the amount of change is less than the adjustable volume portion 11200.

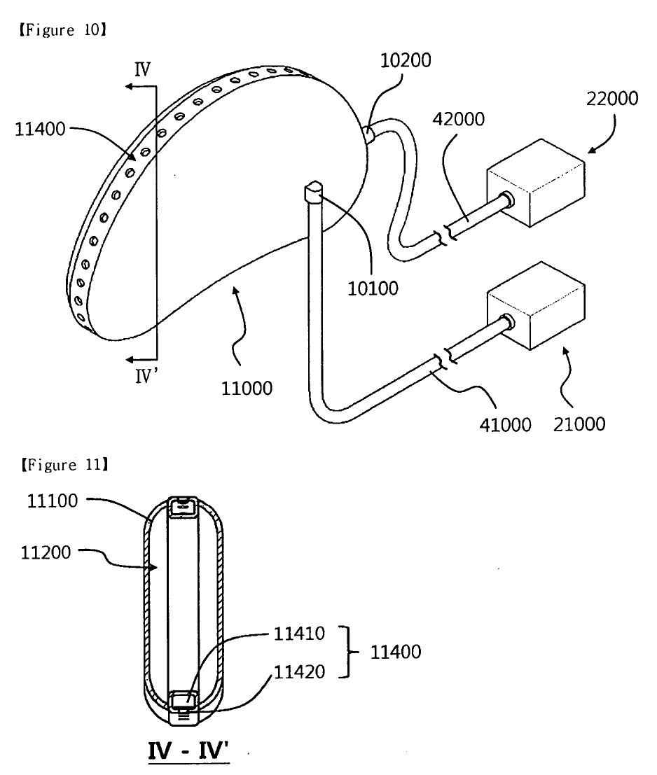

FIG. 10 is a perspective view of an assistant apparatus for oral treatment according to still another example embodiment of the present invention. FIG. 11 is a cross-sectional view of an oral cavity insertion member of FIG. 10, taken along a line IV-IV'.

The example embodiment of FIGS. 10 and 11 has an additional structure for increasing an adhesive force between an inner surface of the oral cavity 1100 of a patient 1000 and the oral cavity insertion portion 11000, which has been described with reference to FIGS. 3 to 12, and it can be combined with the structures of FIGS. 3 to 12.

An oral cavity adhesion portion 11400 is fixed to the outer circumference (circular arc) of an adjustable volume portion 11100, like a rubber band which is formed on a plastic wheel of a toy car to increase traction.

The oral cavity adhesion portion 11400 includes fluid suction holes 11420 through which air is suctioned to make the oral cavity adhesion portion 11400 adhere to skin inside the oral cavity 1100, or preferably, to the soft palate, due to the suction force. A fluid suction unit 22000 is coupled to the oral cavity adhesion portion 11400 through a fluid transfer tube 42000 and a fluid-suction coupling terminal 10200.

The oral cavity adhesion portion 11400 has an empty space and includes a second fluid passage portion 11410 connected to the fluid-suction coupling terminal 10200. It also has one or more fluid suction holes 11420 which are connected to the second fluid passage portion 11410 and exposed to the outside to adhere to the inner surface of the oral cavity 1100.

The oral cavity adhesion portion 11400 may be formed in a ring shape. In this case, the overall length of the ring-shaped oral cavity adhesion portion 11400 should increase in proportion to the increasing volume of the adjustable volume portion 11200. Therefore, the oral cavity adhesion portion 11400 is preferably formed of polymer or silicon with elasticity. More preferably, the oral cavity adhesion portion 11400 is formed of a material having the same or less elasticity than the inflatable membrane 11100 of the adjustable volume portion 11200.

The oral cavity adhesion portion 11400 may be formed in a belt shape with an opening portion (that is, a shape similar to a horseshoe magnet).

The oral cavity adhesion portion 11400 may be formed in a wing shape which protrudes with a small thickness to correspond to the outer circumference (circular arc) of the adjustable volume portion 11200, like oral cavity insertion members according to other example embodiments of the present invention which will be described below with reference to FIGS. 13 to 14.

For the fluid suction unit 22000, a separate pump or an air pump included in the unit chair may be used. When a separate pump is used, it may be a manual or electric pump.

In this example embodiment of the present invention, an air pump included in the unit chair, that is, a suction instrument which is generally used in dental treatment, is used as the fluid suction unit 22000.

FIG. 12 is a diagram showing the structure of the fluid supply according to an example embodiments of the present invention.

In the fluid supply 21000 of the assistant apparatus for oral treatment according to the example embodiments of the present invention described with reference to FIGS. 1 to 11, fluid with a positive pressure generated by the fluid compressor 21100 is supplied to the oral cavity insertion member 11000 through the fluid transfer tube 41000.

The fluid supply 21000 includes a pressure adjuster 21200 which constantly maintains the internal pressure of the oral cavity insertion member 11000 to maintain the expanded volume of the oral cavity insertion member 11000. It also includes a discharge unit 21300 that has a pressure discharge pin 21310 and discharges the fluid supplied to the oral cavity insertion member 11000 to the outside, in order to easily remove the oral cavity insertion member 11000 from the oral cavity 1100 after the oral treatment.

In an emergency during treatment, a healthcare practitioner removes the pressure discharge pin 21310 such that the fluid supplied to the oral cavity insertion member 11000 is forcibly discharged to the outside to reduce the volume of the oral cavity insertion member 11000. Then, the oral cavity insertion member 11000 is removed from the oral cavity.

For the pressure adjuster 21200, a mechanical relief valve is generally used to set a predetermined pressure.

FIGS. 13 to 21 are diagrams for explaining oral cavity insertion members according to other example embodiments of the present invention.

In the oral cavity insertion member 11000 described with reference to FIGS. 2 to 12, the volume is altered by a provided positive pressure.

Therefore, the oral cavity insertion member 11000 easily fits into the oral cavity structure of each patient. However, the oral cavity insertion member 11000 may be torn by a sharp instrument such a drill or pick during oral treatment.

An oral cavity insertion member 12000, which will be described below with reference to FIGS. 13 to 21, adheres to the oral cavity 1100, or preferably, to the soft palate, due to a negative pressure, thereby preventing washing liquid or saliva from entering the throat.

The oral cavity insertion member 12000 is roughly divided into a body portion 12100 and an oral cavity adhesion portion 12200.

The body portion 12100 includes a fluid-suction coupling terminal 10200 which is coupled to a fluid transfer tube 42000 for providing a negative pressure, and a connection path 12500 which connects the oral cavity adhesion portion 12200 to the coupling terminal 10200 to transfer the negative pressure to the oral cavity adhesion portion 12200.

The body portion 12100 may be formed of a material which maintains a predetermined shape with respect to an external load but is not excessively rigid. In this example embodiment, silicon is used.

As the oral cavity insertion member 12000 adheres to the oral cavity 1100 in front of the uvula 1120, or preferably, to the soft palate, the rear surface 12120 of the oral cavity insertion member 1200, that is, a surface of the body portion 12100 opposite to the coupling terminal 10200, may come in contact with the uvula 1120 and cause the patient 1000 to emesis. To solve this problem, the surface 12120 of the body portion 12100 opposite to the coupling terminal 10200 may be flat or concave.

The body portion 12100 may be formed to have a larger area or width than the throat 1130 such that the oral cavity insertion member 12000 is prevented from entering the throat.

The oral cavity adhesion portion 12200 includes fluid suction holes 12220 which are connected to the connection path 12500 of the body portion 12100 and provided on a surface 12212 opposite to a surface 12211 of the body portion 12100 including the coupling terminal 10200.

The oral cavity adhesion portion 12200 has to easily adhere to the surface of the oral cavity, and may be bent to correspond to the oral cavity structure of the patient. Therefore, the oral cavity adhesion portion 12200 may be thinner than the body portion 12100 and elastic. In this example embodiment, both the oral cavity adhesion portion 12200 and the body portion 12100 are formed of silicon.

The oral cavity insertion member 12000 includes a respiration hole 12300 which passes through the body portion 12100 and is blocked from the connection path 12500 within the body portion 12100. Therefore, when the oral cavity insertion member 12000 is inserted into the oral cavity, the patient can breathe through the mouth as well as the nose.

At this time, since the patient 1000 lies in the unit chair for oral treatment, the respiration hole 12300 may be formed to protrude from the front side of the body portion 12100, that is, the surface 12110 including the fluid-injection coupling terminal 10200, such that washing liquid or saliva in the oral cavity 1100 is prevented from entering the patient's throat through the respiration hole 12300 included in the body portion 12100.

Further, the respiration hole 12300 may have a thin film formed at its leading end. The thin film is cut in a cross (+) shape such that washing liquid jetted onto the teeth of the patient during treatment is prevented from splashing and entering the throat of the patient through the respiration hole 12300.

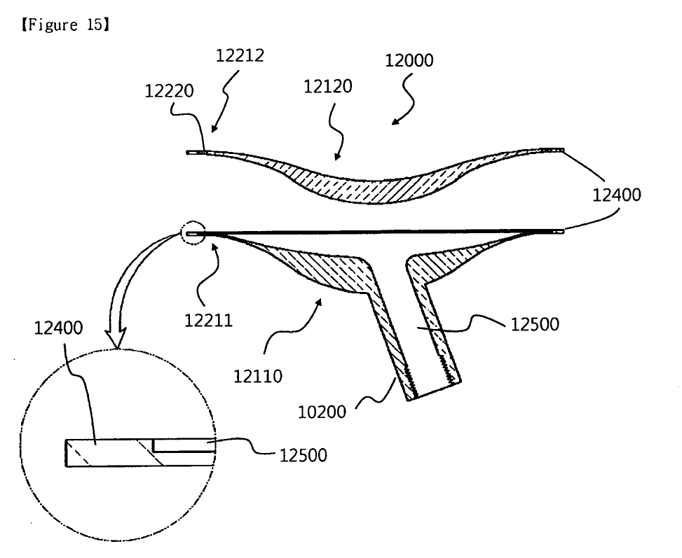

FIG. 15 is an exploded cross-sectional view of the oral cavity insertion member 12000 shown in FIGS. 13 and 14.

The body portion 12100 and the oral cavity adhesion portion 12200 of the oral cavity insertion member 12000 according to an example embodiments of the present invention may be formed as one integrated body.

That is, the surfaces 12120 and 12212 corresponding to the throat side and the surfaces 12110 and 12211 including the coupling terminal 10200 are injection-molded of silicon and then bonded to each other through bonding portions 12400.

In this case, the coupling terminal 10200, which is included at the surface 12110 of the body portion 12100, may have a screw thread formed therein to be easily coupled to the fluid transfer tube 42000 connected from the fluid suction unit 22000. The screw thread may be a female screw thread formed inside the coupling terminal 10200, as shown in FIG. 11, or a male screw thread formed outside the coupling terminal 10200.

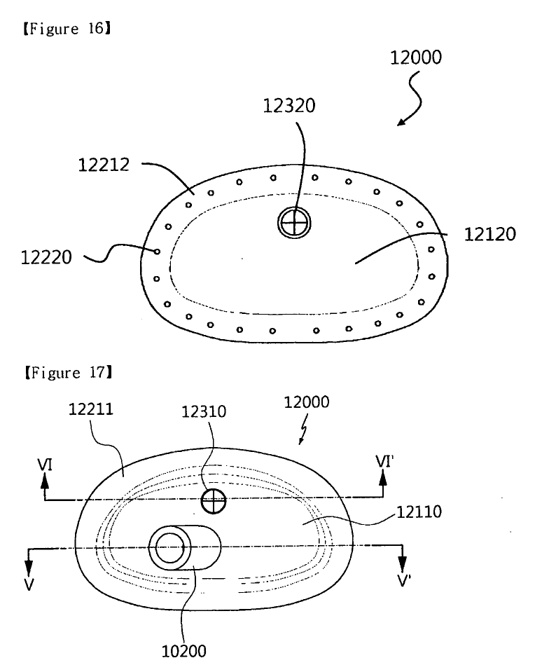

FIG. 16 is a diagram illustrating the rear surface of the oral cavity insertion member 12000 according to an example embodiments of the present invention, that is, a surface close to the throat when the oral cavity insertion member is inserted into the oral cavity. FIG. 17 is a diagram illustrating the front surface of the oral cavity insertion member 12000, that is, a surface including the coupling terminal 10200.

Referring to FIGS. 16 and 17, the fluid suction holes 12220 of the oral cavity insertion member 12000 are included in only one side surface of the oral cavity adhesion portion 12200, that is, the surface 12212 of the oral cavity adhesion portion 12200 close to the throat when the oral cavity insertion member 12000 is inserted into the oral cavity.

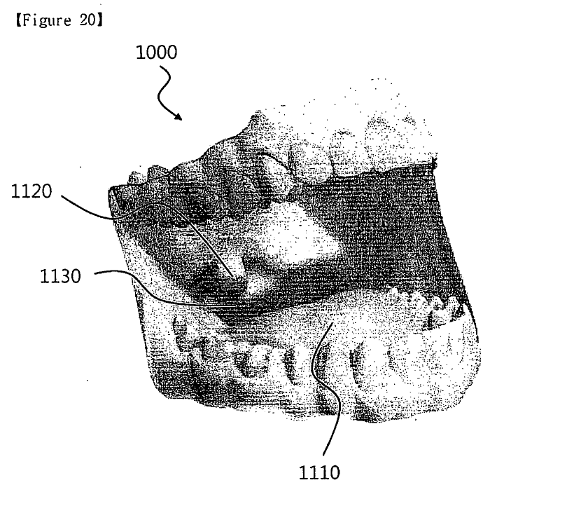

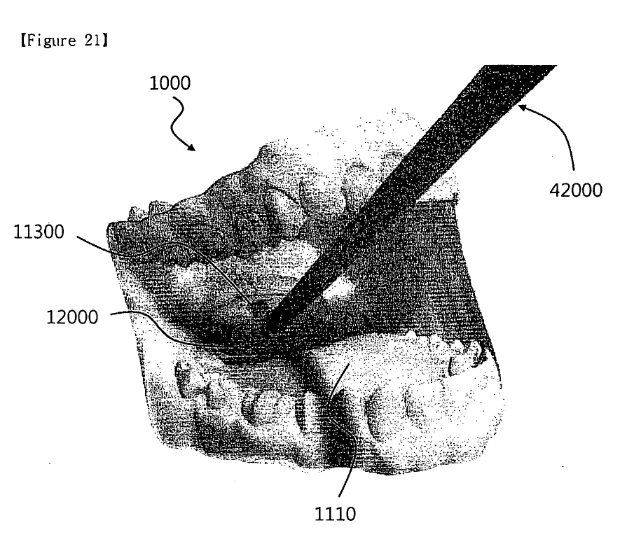

FIG. 20 is a 3D-modeled perspective view of the oral cavity 1100 before the oral cavity insertion member 10000, 11000, or 12000 according to an example embodiments of the present invention is inserted. FIG. 21 is a 3D-modeled perspective view of the oral cavity 1100 when the oral cavity insertion member 10000, 11000, or 12000 is inserted.

The oral cavity insertion member 10000, 11000, or 12000 according to an example embodiments of the present invention may be connected to the fluid supply 21000 or the fluid suction unit 22000 through the fluid transfer tube 41000 or 42000. Alternatively, the oral cavity insertion member 10000, 11000, or 12000 may be inserted into the oral cavity without being connected to the fluid supply 21000 or the fluid suction unit 22000.

When the oral cavity insertion member 10000, 11000, or 12000 is inserted into the oral cavity without being connected to the fluid supply 21000 or the fluid suction unit 22000, a handle or the like may be provided to easily insert or remove the oral cavity insertion member 10000, 11000, or 12000. The handle will be described below with reference to FIG. 24.

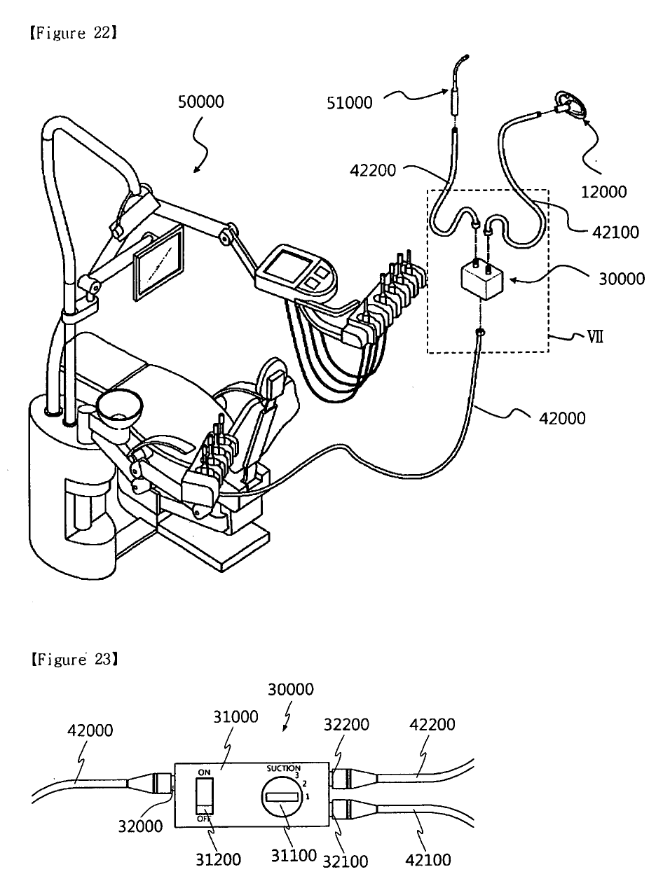

FIG. 22 is a perspective view of an assistant apparatus for oral treatment including dental treatment and a unit chair equipped with the same according to an example embodiment of the present invention.

The unit chair 50000, which is generally used for dental treatment, typically includes two fluid suction instruments which provide high and low pressure, respectively.

The assistant apparatus according to an example embodiments of the present invention may be formed similar to an instrument such as a drilling tool in the unit chair 50000. A suction 51000 connected to the fluid suction unit may be removed, and the oral cavity insertion member 10000, 11000, or 12000 (preferably the oral cavity insertion member 12000 which has a suction function) may be connected to the fluid transfer tube 42000.

The assistant apparatus may further include a connector 30000 for facilitating the connection.

A coupling method using the connector will be described with reference to FIG. 23, which illustrates a region VII of FIG. 22 represented by a dotted line.

The connector 30000 includes two terminals. Between them, one terminal 32000 is coupled to the second fluid transfer tube 42000 connected to the fluid suction unit of the unit chair 50000, and the other terminal 32100 is coupled to the first fluid transfer tube 41000 connected to the oral cavity insertion member 10000, 11000, or 12000 (preferably the oral cavity insertion member 12000 which has a suction function).

The connector 30000 may include a terminal 32200 which is coupled to a third fluid transfer tube 42200 connected to the removed suction 51000, in addition to the one terminal 32000 which is coupled to the second fluid transfer tube 42000 connected to the fluid suction unit of the unit chair 50000 and, the other terminal 32100 which is coupled to the first fluid transfer tube 42100 connected to the oral cavity insertion member 10000, 11000, or 12000.

The connector 30000 may include a control lever 31100 for controlling a negative pressure provided from the fluid suction unit. The negative pressure provided to the oral cavity insertion member 12000 can be controlled by the control lever.

Further, the connector 30000 may include a pressure control valve which is generally used for controlling pressure (negative pressure).

Further, when an electric/electronic pressure control valve is used instead of a mechanical pressure control valve, the connector 30000 may further include an on/off switch 31200 for turning power on/off.

FIG. 24 is a perspective view of an assistant apparatus for oral treatment according to still another example embodiment of the present invention. In this example embodiment, the oral cavity insertion member 10000, 11000, or 12000 is not used in a state in which it is connected to the fluid supply 21000 or the fluid suction unit 22000, but is used in a state in which it is inserted into the oral cavity of a patient.

The assistant apparatus for oral treatment includes a handle 60000 for inserting or removing the oral cavity insertion member 10000, 11000, or 12000.

The handle 60000 includes a handle body 61000 which is coupled to one surface of the oral cavity insertion member 10000, 11000, or 12000, and a grip portion 62000 which has an irregular portion formed opposite to the handle body 61000 to be easily gripped by a healthcare practitioner.

To more easily remove the oral cavity insertion member 10000, 11000, or 12000 from the oral cavity, the handle 60000 may further include a hook 63000 formed on a predetermined region of the handle body 61000.

The assistant apparatus for oral treatment may be constructed in such a manner that the oral cavity insertion member 10000, 11000, or 12000 can be separated from the handle 60000. In this case, after the oral cavity insertion member is inserted into the oral cavity, the handle 60000 can be separated from the oral cavity insertion member.

Further, an adhesive material may be applied to a surface facing the throat of the patient, opposite to the oral cavity insertion member 10000, 11000, or 12000 to which the handle 60000 is coupled. Then, the oral cavity insertion member can be attached to skin inside the oral cavity when the oral cavity insertion member is inserted.

In the oral cavity insertion members described above with reference to FIGS. 13 to 19, a negative pressure does not need to be used. Therefore, the connection path 12500, the fluid suction holes 12220, etc. may be excluded.

The oral cavity adhesion portion 12200 formed on the outer circumference (circular arc) of the body portion 12100 maybe thin, wing-shaped and injection-molded together with the body portion 12100 as one integrated body.

In the drawings and specification, typical exemplary embodiments of the invention have been disclosed, and although specific terms are employed, they are used in a generic and descriptive sense only and are not for the purposes of limitation, the scope of the invention being set forth in the following claims.

1. An assistant apparatus for oral treatment, comprising:
an oral cavity insertion member that includes an adjustable volume portion of which volume is expandable by fluid; and
a fluid supply configured to supply the fluid to the adjustable volume portion.

2. The assistant apparatus according to claim 1, wherein the oral cavity insertion member further includes a fixed volume portion which is fixed to a predetermined portion of the adjustable volume portion, and the volume of the fixed volume portion is not expanded by the supply of the fluid.

3. (canceled)

4. The assistant apparatus according to claim 1, wherein the oral cavity insertion member further includes an oral cavity adhesion portion which has one or more fluid suction holes to which the pressure of a fluid suction unit is transmitted for adhesion to skin inside the oral cavity of a patient.

5. An assistant apparatus for oral treatment, comprising:
an oral cavity insertion member that is inserted into an oral cavity in front of a uvula of a patient to prevent washing liquid used during the oral treatment or saliva from entering a gullet or an airway of the patient,
wherein the oral cavity insertion member includes an oral cavity adhesion portion which is adhered to skin inside the oral cavity of the patient.

6. The assistant apparatus according to claim 5, wherein the oral cavity insertion member is formed of an elastic material whose shape is changeable by external pressure.

7. (canceled)

8. The assistant apparatus according to claim 5, wherein the oral cavity adhesion portion includes fluid suction holes where a negative pressure is formed when the oral cavity adhesion portion is adhered to the skin inside the oral cavity of the patient.

9. An assistant apparatus for oral treatment comprising an oral cavity insertion member, the oral cavity insertion member including:
a body portion that includes a connection path through which fluid is able to flow;
an oral cavity adhesion portion that is provided on an outer circumference of the body portion and adhered to skin inside an oral cavity of a patient; and
at least one fluid suction holes that is formed on one surface of the oral cavity adhesion portion to be connected to the connection path.

10. The assistant apparatus according to claim 9, wherein the oral cavity adhesion portion is thinner than the body portion.

11. (canceled)

12. (canceled)

13. The assistant apparatus according to claim 9, further comprising:
a coupling terminal that couples a fluid transfer tube connected to a fluid suction unit to the connection path included in the body portion.

14. The assistant apparatus according to claim 13, wherein the coupling terminal is formed on one surface of the body portion opposite to the surface where the fluid suction holes are formed.

15. (canceled)

16. (canceled)

17. The assistant apparatus according to claim 13, wherein the fluid transfer tube includes a first fluid transfer tube connected to the coupling terminal, and a second fluid transfer tube connected to the fluid suction unit, and wherein the assistant apparatus further includes a connector configured to connect the first fluid transfer tube to the second fluid transfer tube.

18. (canceled)

19. The assistant apparatus according to claim 9, wherein the oral cavity insertion member further includes a respiration hole which is formed to pass through the body portion.

20. The assistant apparatus according to claim 19, wherein the respiration hole is formed to protrude from one surface of the body portion opposite to the surface where the fluid suction holes are formed.

21. (canceled)

22. The assistant apparatus according to claim 19, wherein the respiration hole is physically blocked from the connection path included in the body portion.

23. The assistant apparatus according to claim 9, wherein the surface of the body portion on which the fluid suction holes are formed is concave or flat.

24. An assistant apparatus for oral treatment comprising an oral cavity insertion member, the oral cavity insertion member including:
a body portion having a predetermined thickness; and
an oral cavity adhesion portion that is provided on an outer circumference of the body portion and is thinner than the predetermined thickness of the body portion.

25. The assistant apparatus according to claim 24, wherein an adhesive material is applied on at least a portion of one surface of the oral cavity adhesion portion.

26. A unit chair for oral treatment, comprising:
an oral cavity insertion member including:
a body portion having a connection path formed therein, through the connection path fluid is able to flow;
an oral cavity adhesion portion that is provided on an outer circumference of the body portion and adhered to skin inside an oral cavity of a patient; and
at least one fluid suction holes that is formed on one surface of the oral cavity adhesion portion to be connected to the connection path; and
a fluid suction unit that is connected to the connection path and provides a negative pressure to the fluid suction holes.

27. The unit chair according to claim 26, further comprising:
a connector that connects a first fluid transfer tube connected to the connection path to a second fluid transfer tube connected to the fluid suction unit.

28. The unit chair according to claim 27, wherein the connector includes a pressure control valve configured to control a pressure provided to the fluid suction holes from the fluid suction unit.
